(19) United States
(12) Patent Application Publication
(10) Pub. No.: US 2011/0171517 A1
(43) Pub. Date: Jul. 14, 2011

(54) TEARABLE BATTERY TUBING AND BATTERY WRAPPED WITH THE SAME

(75) Inventors: Yu Chang LEE, Tainan County (TW); Sung Yi TSAI, Tainan County (TW); Chun Sheng SU, Tainan County (TW)

(73) Assignee: E-ONE MOLI ENERGY CORP., Tainan County (TW)

(21) Appl. No.: 12/984,859

(22) Filed: Jan. 5, 2011

(30) Foreign Application Priority Data
Jan. 11, 2010 (TW) 099200462

(51) Int. Cl. H01M 2/02; B32B 1/08; B65D 17/34; B65D 17/28

(52) U.S. Cl. 429/163; 428/34.9

(57) ABSTRACT

A battery tubing according to the present invention is provided. The battery tubing is hollow and shrinkable. The battery tubing has at least one perforation line and a user can easily tear the battery tubing along the perforation line. The present invention further provides a battery wrapped with the above battery tubing.

### CROSS REFERENCE TO RELATED APPLICATION

This application claims the priority benefit of Taiwan Patent Application Serial Number 099200462 filed Jan. 11, 2010, the full disclosure of which is incorporated herein by reference.

### BACKGROUND OF THE INVENTION

1. Field of the Invention

The invention relates to a battery tubing and a battery wrapped with the battery tubing, and more particularly, to a tearable battery tubing and a battery wrapped with the tearable battery tubing

2. Description of the Related Art

Referring to FIG. 1, a conventional battery 100 is wrapped with a protection tubing 110 on the lateral surface thereof after being manufactured. The protection tubing 110 can protect the battery 100 from short-circuit during shipment or operation. In general, the above battery 100 can provide only a limited electric power and a fixed voltage, said 1.5V. Therefore, it is necessary to have several batteries 100 in series or parallel connection in order to obtain a higher voltage output or more electric power.

In order to avoid manually coupling several batteries 100 for a user when desiring to use a high-voltage driving or high-power consumption device, some vendors have begun to pack several batteries 100 in a module in advance for ready use. Since the protection tubings 110 will hinder the batteries 100 from heat dissipation, the protection tubings 110 are taken off from the batteries 100 before the batteries 100 are packed in a module. This manner the heat generated by these batteries 100 can be easily dissipated.

However, the protection tubings 110 usually tightly wrap the batteries 100. Therefore, it is somewhat difficult to take off the protection tubings 110 from the batteries 100. Besides, the batteries 100 are often scratched by tools during removal of the protection tubings 110.

Accordingly, there exists a need to provide a novel battery tubing to solve the above-mentioned problems.

### SUMMARY OF THE INVENTION

The present invention provides a tearable battery tubing.

In one embodiment, the battery tubing is hollow and shrinkable, and has two parallel perforation lines for tearing.

The present invention further provides a battery wrapped with the above the battery tubing.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a conventional battery.

FIG. 2 is one aspect of the tearable battery tubing of the present invention.

FIG. 3 is another aspect of the tearable battery tubing of the present invention.

FIG. 4 is the battery of the present invention, wherein the lateral surface of the battery is wrapped with the tubing of FIG. 2.

FIG. 5 is the battery of the present invention, wherein the lateral surface of the battery is wrapped with the tubing of FIG. 3.

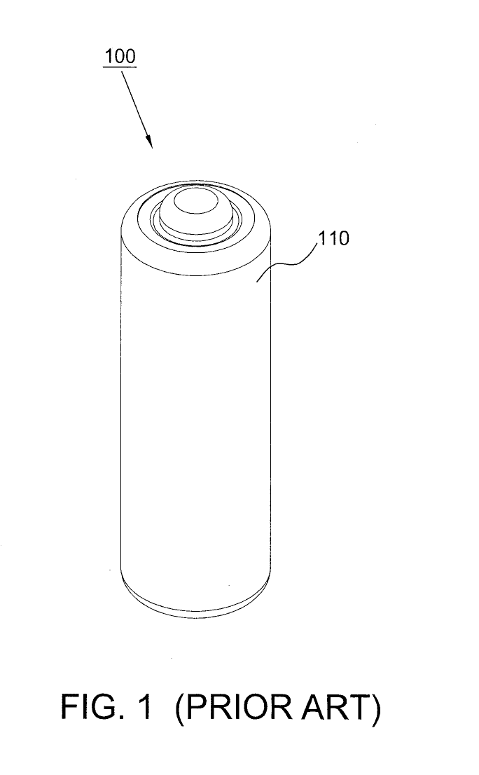

### DETAILED DESCRIPTION OF THE PREFERRED EMBODIMENT

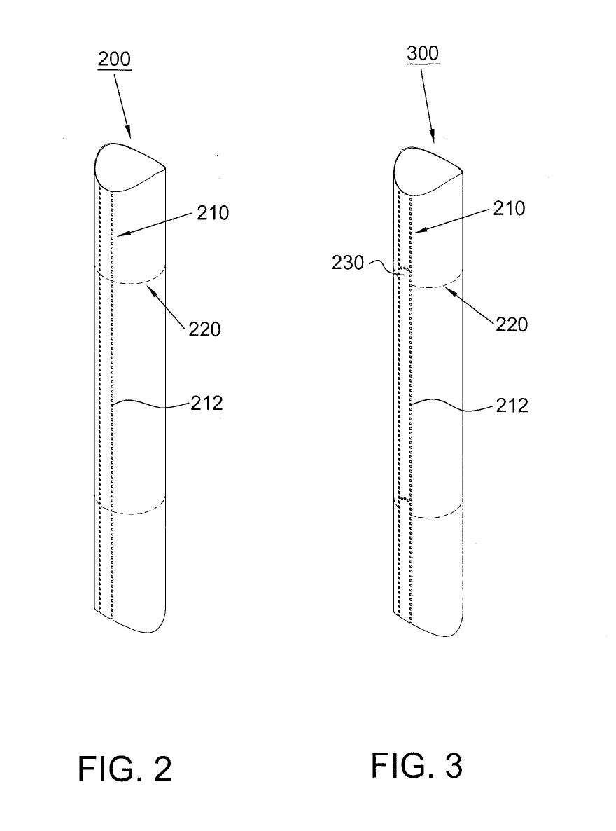

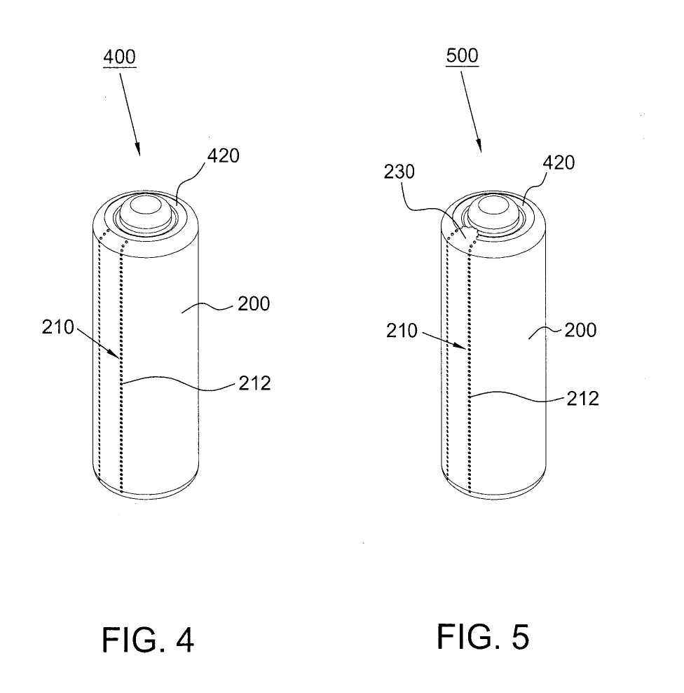

Referring to FIG. 2, the tearable battery tubing 200 of the present invention is configured to wrap a battery, for example, to wrap the battery body 420 of FIG. 4. The tubing 200 is hollow and shrinkable. For example, the tubing 200 can be a heat shrink tubing. In addition, the tubing 200 has at least one perforation line 210 for tearing, for example, two perforation lines 210 aligning parallel to the axis thereof. With such design, an operator can tear the tubing 200 along the perforation lines 210. In the present invention, the gaps of the perforation lines 210 are 0.5 mm and the perforation line 210 is formed with a plurality of discrete openings 212 aligning in a line.

When an operator would like to use the tubing 200 of the present invention to wrap the battery body 420, the operator can cut the tubing 200 along the cut line 220 for a desired length. Afterward, the battery body 420 is inserted into the tubing 200 and the tubing 200 is heated to shrink to wrap the lateral surface of the battery body 420. In this embodiment, the tubing 200 can be heated to shrink with an oven or heat gun. After the tubing 200 wraps the tubing 200, the perforation lines 210 axially extend from one end to the other end of the tubings 200 (see the battery 400 of FIG. 4).

When an operator would like to use these batteries 400 wrapped with the tubings 200 to form a battery module, the operator can tear up the tubings 200 along the perforation lines 210 to take out the battery bodies 420 without need to exert a large force. This solves the prior art problem that the protection tubings are hard to be removed from batteries.

In addition, referring to FIGS. 3 and 5, in order to facilitate an operator to tear up the tubing 300, a tab 230 is positioned on the edge of the tubing 300 and between the two perforation lines 210. When the tubing 300 of FIG. 3 is heated to shrink to wrap the battery body 420, a battery 500 as shown in FIG. 5 is formed. Afterward, an operator can grip and pull the tab 230 outward to tear up the tubing 300. This manner the battery body 420 can be easily taken out.

Although the battery bodies shown in the figures of the present invention are all cylindrical, it will be appreciated that the battery tubings of the present invention can also be used to wrap other shapes of battery bodies, for example, rectangular battery bodies.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A battery tubing configured to wrap a battery, characterized in that the battery tubing is shrinkable, wherein the battery tubing has at least one perforation line for tearing.

2. The battery tubing as claimed in claim 1, wherein the at least one perforation line extends from one end to the other end of the battery tubing.

3. The battery tubing as claimed in claim 1, wherein the battery tubing has two perforation lines aligning parallel to each other.

4. The battery tubing as claimed in claim 3, wherein the battery tubing further has a tab positioned on the edge thereof and between the two perforation lines.

5. The battery tubing as claimed in claim 1, wherein the battery tubing is a heat shrink tubing.

6. The battery tubing as claimed in claim 1, wherein the at least one perforation line is formed with a plurality of discrete openings aligning in a line.

7. A battery, comprising:
a battery body having a lateral surface; and
a tubing wrapping the lateral surface of the battery body, wherein the tubing has at least one perforation line for tearing.

8. The battery as claimed in claim 7, wherein the at least one perforation line extends from one end to the other end of the tubing.

9. The battery as claimed in claim 7, wherein the tubing has two perforation lines aligning parallel to each other.

10. The battery as claimed in claim 9, wherein the tubing further has a tab positioned on the edge thereof and between the two perforation lines.

11. The battery as claimed in claim 7, wherein the at least one perforation line is formed with a plurality of discrete openings aligning in a line.

12. The battery as claimed in claim 7, wherein the battery body is cylindrical.

13. The battery as claimed in claim 7, wherein the battery body is rectangular.
